(19) United States
(12) Patent Application Publication
(10) Pub. No.: US 2024/0159006 A1
(43) Pub. Date: May 16, 2024

(54) Utility Scale Hydro Pump System and Method

(71) Applicant: Brent K Park, Falls Church, VA (US)

(72) Inventor: Brent K Park, Falls Church, VA (US)

(21) Appl. No.: 17/985,937

(22) Filed: Nov. 14, 2022

(51) Int. Cl. E02B 9/00; F03B 13/06; F03B 15/00

(52) U.S. Cl. CPC E02B 9/00; F03B 13/06; F03B 15/005; F05B 2210/11; F05B 2260/422

(57) ABSTRACT

Utility Scale Hydro Pump (USHP) uses a vehicle in a uniquely configured water tower to generate hydro potential energy and electricity. The vehicle operates in the lower chamber of the water tower. The upper chamber has two distinct compartments: the body chamber just above the lower chamber to hold water for the vehicle to pump, and a tall and slender head chamber for the head. As the vehicle is lifted from the lower chamber to pump water in the upper chamber into an upper reservoir, a void in the lower chamber is produced simultaneously. The void is the reduced vehicle volume in the lower chamber and gets filled with recycled water from the lower reservoir. USHP releases water from the upper reservoir to generate electricity, and hydro discharge from a hydro turbine generator is collected and recycled in the lower reservoir.

### BACKGROUND OF THE INVENTION

Developing and deploying additional hydropower are essential to achieving comprehensive clean and renewable energy solutions. Hydroelectric power plants use water flowing through hydro turbine generators to generate electricity. Water is renewed and supplied by snow or rainfall. Less discussed, but crucially important is a pumped-storage hydropower (PSH) that uses excess power from the grid to pump water into an upper reservoir, and then release to generate electricity as needed. Although current PSH uses more energy than it can generate, it is effective in storing hydro potential energy. A typical PSH upper reservoir is large enough to hold water for 8 to 10 hours of power generation.

Expanding hydropower capacities requires a large reservoir at higher elevation and often substantial initial capital costs. Siting requirements for hydropower facilities demand adequate rainfall or water availability to replenish water. Environmental impacts may not be ignored for PSH facilities as some operate with more than 300-m heads. Because they are typically built on hills, it might take up to −4 km distance to achieve the head.

There are hundreds of solar, wind, and battery storage development efforts waiting to connect to the grid. Adding standalone hydropower systems will face the same difficulties with interconnections unless they are more reliable than currently available energy options waiting to be integrated into existing grid or they require substantially less capital investment for new grid.

The present invention introduces the utility scale hydro pump (USHP) system and method to address some of these limitations and challenges. USHP is purposefully designed to be practical by making the system modular, scalable, additive, and environmentally friendly. With predictable and steady power generation, USHP is relatively easy to integrate into existing infrastructure or operate as standalone power production (SPP) units. Unlike solar and wind energy, USHP requires much less land and could be built at or near the location of power consumption. Furthermore, USHP is not affected by weather and operates on demand.

The present invention is an innovative hydro-mechanical system to efficiently pump water to an upper reservoir by generally following the vertical mechanical separation of water (VMSW) method.

### FIELD OF THE INVENTION

The present invention provides water at a higher elevation, as input fuel to various applications for the energy storage and hydroelectric power industries.

### THE PRIOR ART

The prior art systems recognize the benefits of using combinations of buoyancy and gravity to gain potential energy that could be converted to other forms of energy including electricity.

U.S. Ser. No. 11/415,097B1 describes VMSW system and method to solve a very difficult problem of placing a buoyant object or adding water into the lower chamber of the water tower without losing water from the lower chamber.

VMSW regulates the useable volume for water near the top of the water tower to change the water level in the water tower. A positively buoyant driver moves vertically following the water level. As the driver moves up, a void is produced in the lower chamber—equal to the volume of the driver no longer in the lower chamber. Water from the lower reservoir, through a sliding watertight recycle door, flows down to fill the void in the lower chamber. After releasing water to the upper reservoir near the top of the water tower, to restore the system back to the initial settings for repeating the operation, the water level once again is changed. Upper reservoir water is released to generate electricity. Hydro discharge, water, enters back into the lower reservoir and recycled. System capacity is determined by the water volume pumped into an upper reservoir per unit time and the head minus energy to operate VMSW.

VMSW capacity is directly proportional to the volume of the driver operating in the water tower. U.S. Ser. No. 11/415,097B1 provides simple qualitative energy calculations using a cylindrical driver with radius of 1.7-m and 70-m length to achieve 50-m head to generate electricity comparable to 1-megawatt (MW) wind turbine generator (WTG). Although the calculation is for illustrative purposes, VMSW uses a ˜500 MT driver. To double the output, VMSW would need the driver twice as large, making the water tower also twice as large and heavy.

Other prior art systems attempt to generate power using various techniques to insert, inject, or circulate buoyant objects. US20140196450A1 describes a method to gain potential energy by inserting buoyant objects through several chambers, leading the object to the top of the water tank. WO2014/128729A2 uses a hollow launching chamber in the lower part of the water tank. U.S. Pat. No. 5,944,480A, JPH10141204A, JP2002138944A, and DE102012009226A1 rely upon either a vacuum effect to retain liquid in the tube or use a watertight seal to slide balls into the tube or apply air pressure in the drive system to load. US20190338747A1 features a start/stop system with buoyant modules moving through a bi-level water tank. US20140130497A1 explains a system that relies on fluid flow due to pressure differentials to perform the work. US20130318960A1 uses a bladder to control buoyancy mechanism while U.S. Pat. No. 8,456,027B1 describes a system to rotate the driver shaft by alternately charging the buoyancy vehicles with the pressurized gas.

US20060042244A1 provides details of a fluid shaft used in a hermetically sealed buoyancy chamber. U.S. Pat. No. 4,718,232A discloses a closed-loop system with multiple valves with pressure control design. WO2014/035267A1 uses floating devices alternatively to generate power while U.S. Pat. No. 8,516,812B2 discloses a vertical pipe system to float objects. JP2020190243A disclosure uses a floating object in a water tank.

### Technical Problem

VMSW is heavy and difficult to build and operate. Furthermore, continuously changing the water level in the water tower to raise, hold, and lower an extremely large and heavy driver presents difficult engineering challenges.

### Solution to Problem

To be practical and competitive with other renewable energy options, it is necessary to significantly reduce the dimensions and mass of the water tower to mitigate safety concerns as well as minimize costs to build and operate—without compromising the system capacity.

### BRIEF SUMMARY OF THE INVENTION

The USHP designation is used to describe both the method and the system, including all the components as well as the physical structures. For USHP, the water tower designation is used specifically for vertically arranged lower chamber and upper chamber and all components in these chambers, to clearly describe the water volume in the water tower during various stages of the operation.

Top of the lower chamber and bottom of the upper chamber share a chamber opening. The lower chamber, via a sliding watertight recycle door, is connected to a lower reservoir. The lower reservoir collects, stores, and supplies (recycled) water to the lower chamber of the water tower. The lower reservoir water level is maintained to be higher than the top of the lower chamber to continuously supply water to the lower chamber. The top of the upper chamber is connected to an upper reservoir.

Although there could be many different variations, USHP prefers to use a compressible vehicle to push or pump water into the upper reservoir. The vehicle volume generally defines the maximum amount of water that could be pumped into the upper reservoir and the vehicle's height determines the lower chamber height. When lifted or compressed, the vehicle bottom may be flush with the top of the lower chamber or any height up to this point.

USHP upper chamber has a unique combination of a body chamber and a head chamber. The body chamber directly above the lower chamber, has at least the same shape and volume as the vehicle. The head chamber, above any location on top of the body chamber at any angle, is drastically reduced and its inner cross section is much smaller than that of the body chamber. Smaller cross section of the head chamber compared to that of the body chamber allows USHP to reduce the original VMSW water tower volume and mass by up to 90% or more.

Using a mechanical lifting device (MLD), USHP lifts or compresses the vehicle to produce a void without losing original water in the lower chamber and without sharing water between the lower and upper chambers while the vehicle is lifted. As the vehicle is lifted, a void with the volume equivalent to the vehicle volume no longer in the lower chamber is produced. The void, as produced, gets filled with water from the lower reservoir through a recycle door. Lifting the vehicle results in pumping, through the chamber opening, water in the upper chamber into the upper reservoir.

Water released from the upper reservoir is used to turn a hydro turbine generator and its hydro discharge or exiting water from the hydro turbine generator replenishes the lower reservoir. Without force applied, the vehicle, with its base open and MLD disengaged and lowered, would sink or decompress and be at the bottom of the lower chamber for repeat operations.

While leaving the rest of the system about the same, making the head chamber taller increases the system capacity. USHP is a practical and buildable translation of the VMSW water tower system.

### BRIEF DESCRIPTION OF THE DRAWINGS

The drawings show preferred embodiments and are not intended to limit the scope of the present invention.

FIG. 1 is a schematic diagram of a side view (SDSV) of the USHP.

FIG. 2a is a SDSV of a water tower structure. A vehicle is not shown to further highlight a chamber opening between the lower chamber and the body chamber.

FIG. 2b shows the FIG. 2a in pseudo-3D (SDSV-3D).

FIG. 3a is a SDSV-3D of the upper reservoir from FIG. 1 with the top of the upper reservoir open but protected from debris; FIG. 3b is a schematic diagram of a cross section of the bottom of the upper reservoir shown in FIG. 3a.

FIG. 4a, 4b show the cylindrical vehicle base grill closed and open, respectively. Cylinder-shaped vehicle is used throughout for illustration purposes.

FIG. 5a, 5b show a SDSV-3D of a vehicle with both top and bottom bases closed and open, respectively.

FIG. 5c, 5d show a SDSV-3D of a vehicle with only the bottom base closed and open, respectively.

FIG. 5e, 5f show a SDSV-3D of a compressible vehicle with only the bottom base closed and open, respectively.

FIG. 6a shows a SDSV-3D of a vehicle, as shown in FIG. 5c, in the lower chamber; only a portion of the upper chamber is shown.

FIG. 6b shows a SDSV-3D of a vehicle, as shown in FIG. 5c, lifted to the upper chamber with MLD. The vehicle volume no longer in the lower chamber is the void volume produced.

FIG. 7a shows a SDSV-3D of a compressible vehicle in its natural state with its vertical walls stretched and the bottom base closed; FIG. 7b shows the vehicle isolated from FIG. 7a.

FIG. 7c shows a SDSV-3D of a vehicle lifted with MLD; FIG. 7d shows the vehicle isolated from FIG. 7c. Volume difference in the vehicles between FIG. 7b and FIG. 7d is the void volume produced in the lower chamber in FIG. 7c.

FIG. 8 is a SDSV of USHP showing the starting conditions or initial settings: a vehicle with its base open at the bottom of the lower chamber, a recycle door closed, and the water tower filled with water. Upper reservoir is shown empty to show how it gets filled during subsequent steps of operations. Upper reservoir water level is not a part of the initial settings.

FIG. 9 is a SDSV of USHP showing the compressible vehicle being lifted using MLD. Vehicle base is closed and the recycle door is open to fill the void with water from the lower reservoir. The void is produced from the vehicle volume getting smaller in the lower chamber. Lower reservoir water level drops as the upper reservoir is filled.

FIG. 10 is a SDSV of USHP with the vehicle lifted and the void in the lower chamber is filled with water from the lower reservoir.

FIG. 11 is a SDSV of USHP with the recycle door closed. As the recycle door closes, the vehicle stops pumping water into the upper reservoir.

FIG. 12a is a SDSV of the water tower showing MLD disengaged from the vehicle and lowered; with open base, the vehicle walls start decompressing; FIG. 12b shows the water tower has returned to the initial settings with the vehicle down at the bottom of the lower chamber—with its base open.

FIG. 13a is a SDSV of USHP with the head chamber at an angle off center; FIG. 13b is a SDSV-3D of a portion of a connecting pipe at the top of the head chamber; water flow direction is represented by an arrow.

FIG. 14 is a SDSV of the water tower with a common upper reservoir for three head chambers.

FIG. 15 is a SDSV-3D of a small USHP farm with three rows of USHP systems. Individual components are not labeled, and some parts are not shown such as penstocks and turbine generators—to focus on scale and scalability of USHP farm. USHP farm shares a common lower reservoir, and each row has a common upper reservoir.

### DETAILED DESCRIPTION OF THE INVENTION

USHP could use commonly available sensors and motorized components requiring external power source. Descriptions and functionalities of the commonly used parts are not provided in detail—such as opening or closing a sliding watertight door, etc. Throughout the discussion, each term or terminology represents a unique component, feature, or function to further clarify descriptions and methods.

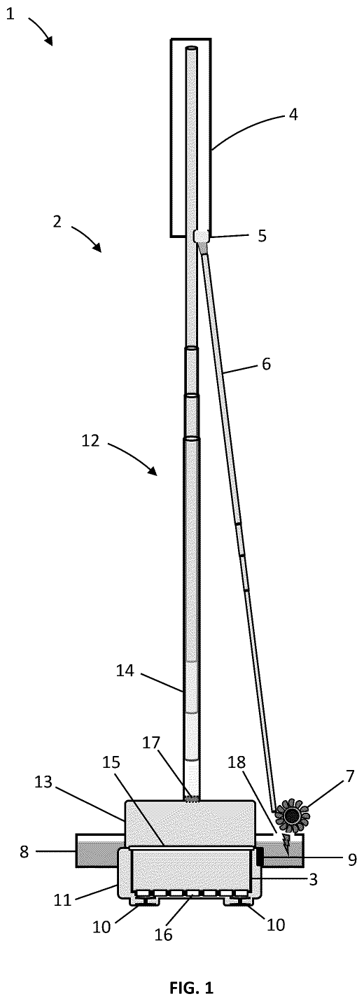

FIG. 1 shows a perspective SDSV of USHP 1—comprising a water tower 2 with a vehicle 3, an empty upper reservoir 4, a reservoir release valve 5, a penstock 6, a turbine generator 7, a lower reservoir 8, a recycle door 9, and MLD 10. The lower reservoir 8 could wrap around the lower part of the water tower 2.

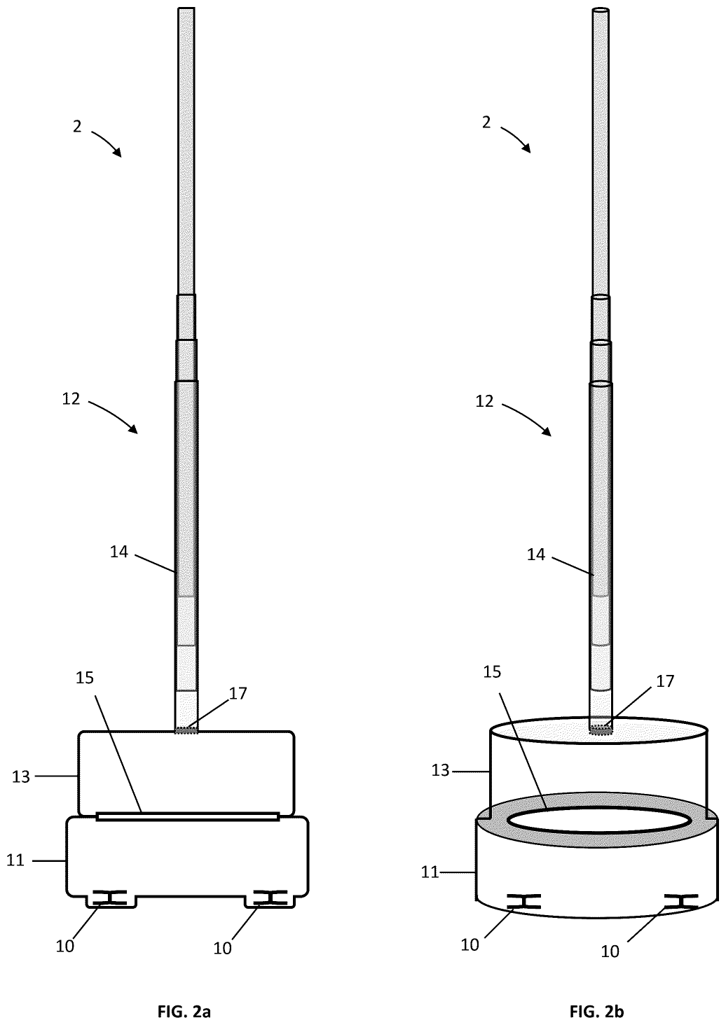

FIG. 2a shows a SDSV of water tower 2 structure comprising a lower chamber 11, likely placed underground and serve as a foundation for the system, and an upper chamber 12 defined to be the sections of the water tower 2 above the lower chamber 11. FIG. 2b is a SDSV-3D of FIG. 2a. The upper chamber 12 further comprises a body chamber 13 and a head chamber 14 that could be extended or retracted. The head chamber 14 could have a single or multiple connections to the body chamber 13. The top of the lower chamber 11 and the bottom of the upper chamber 12 share a chamber opening 15 through which the vehicle 3 pushes or pump water in the upper chamber 12.

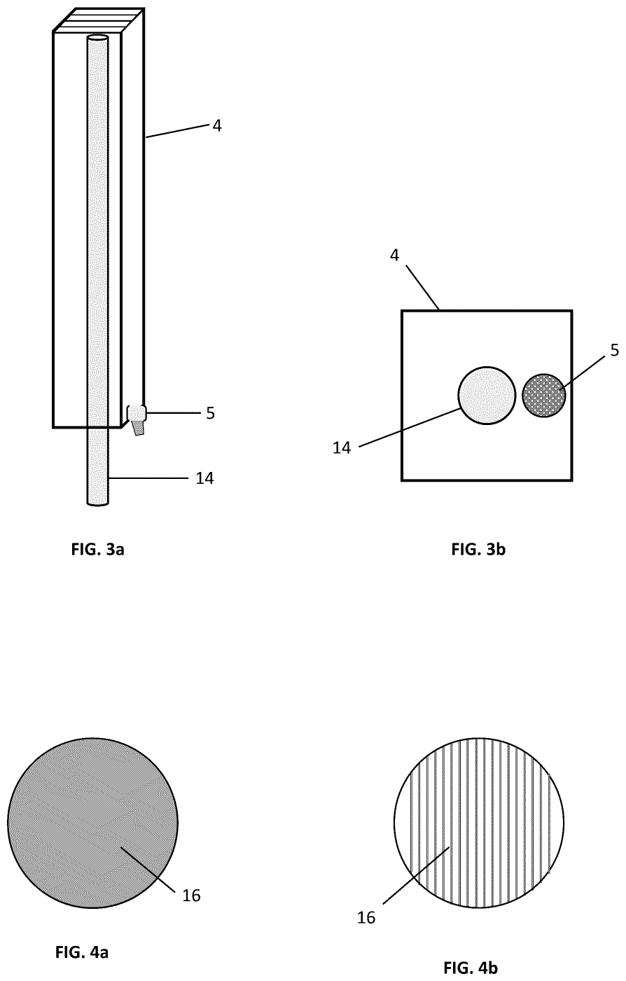

FIG. 3a is a SDSV-3D of the upper reservoir 4 from FIG. 1. Upper reservoir 4 could wrap around the head chamber 14 near the top of the water tower 2 as shown in FIG. 3a. The head is calculated from the water surface of the upper reservoir 4 and not from the location of the reservoir release valve 5 and having large enough upper reservoir 4 for steady water release is important. It is important to keep the top of the upper reservoir 4 protected from weather elements but open to allow for unimpeded water release down through the reservoir release valve 5. FIG. 3b is a schematic diagram of a cross section of the bottom of the upper reservoir 4 showing a reservoir release valve 5 and a head section 14. The upper reservoir 4 could take different shapes and volume.

Vehicle 3, denser than water, rests at the bottom of the lower chamber 11 (FIG. 1), a normal position. It is preferred to have the top of the vehicle 3 flush with the bottom of the upper chamber 12—to minimize the body chamber 13 volume. Vertical movement of the vehicle 3 is generally limited to be less than its height.

Vehicle 3 could take many different shapes and forms. USHP uses a vehicle 3 with removable, foldable, sliding, or openable base 16 to eliminate the need for a separate sliding watertight door between the lower chamber 11 and the upper chamber 12. For a cylindrical vehicle 3, its base 16 could be a grill that closes (FIG. 4a) and opens (FIG. 4b). The lower chamber 11 and the upper chamber 12 need to be separated when the vehicle 3 is being lifted or compressed to pump water into an upper reservoir 4. Water leakage or loss from the upper chamber 12 while the vehicle 3 is being lifted will reduce the system capacity. To prevent unplanned water release from the head chamber 14, one-way waterflow valve 17 could be placed at the bottom of the head chamber 14 (FIG. 1).

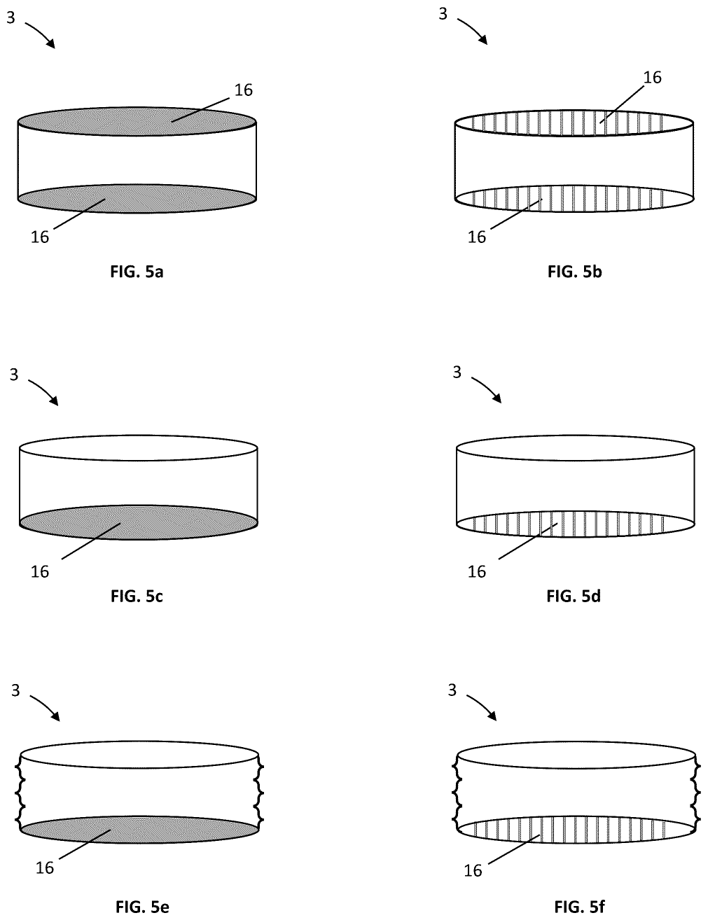

In a simple form, vehicle 3 could have a cylindrical shape (FIG. 5a) with base 16 at both ends. Stretchable watertight bellows, secured between the top of vehicle 3 and the chamber opening 15, would ensure no water loss or leakage from the upper chamber 12 when the base 16 is closed. Completely closing at least one base 16 disconnects whereas opening top and bottom base 16 (FIG. 5b) connects the lower chamber 11 and the upper chamber 12. This vehicle design prefers a symmetrical uniform cross section for the vehicle 3 so as not to require an adjustable mechanism for the chamber opening 15.

To simplify the vehicle operation, USHP uses a vehicle 3 with open top and only the bottom base 16 (FIG. 5c, 5d). Taking this design further, USHP prefers a compressible or collapsible vehicle 3 as shown in FIG. 5e and FIG. 5f.

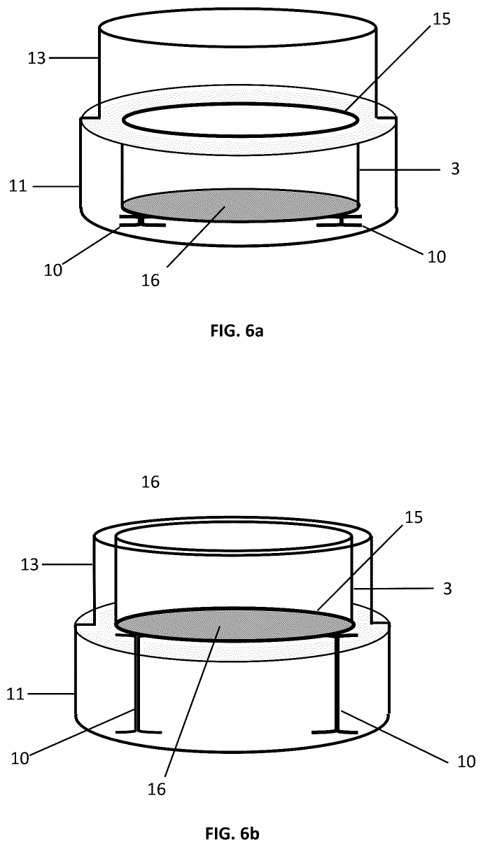

FIG. 6a shows a vehicle 3 from FIG. 5c, in the lower chamber 11 with the base 16 closed. FIG. 6b shows the vehicle 3 from FIG. 5c, lifted to the body chamber 13. The volume of the vehicle 3 no longer in the lower chamber 11 is the void volume that gets filled with water from the lower reservoir 8.

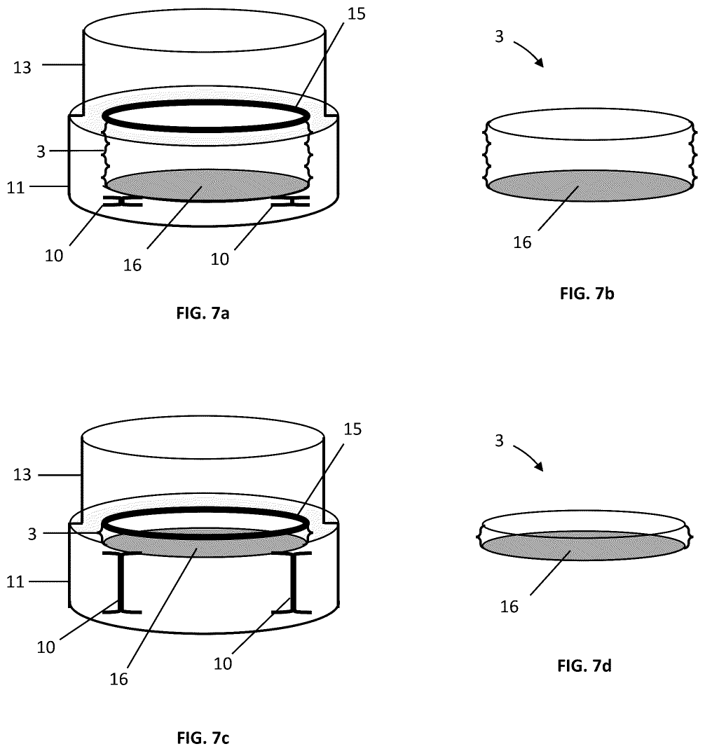

Compressible vehicle 3, as shown in FIG. 7a, 7c, operate in the lower chamber 11. FIG. 7b, 7d show isolated vehicle 3 from FIG. 7a, 7b, respectively. Top edge around the vehicle 3 is secured watertight to the chamber opening 15 and the stretchable watertight bellows are no longer required. With the base 16 closed, the lower chamber 11 and the upper chamber 12 are separated, and the vehicle 3 is ready to be lifted (FIG. 7a). As MLD 10 lifts the vehicle 3, the vehicle 3 walls get compressed while pushing water in the upper chamber 12 into the upper reservoir 4. Again, reduced volume of the vehicle 3 from FIG. 7b to FIG. 7d is the void volume in the lower chamber 11. For simplicity, the rest of the discussion uses the compressible cylindrical vehicle 3 knowing that the vehicle 3 could take many different shapes and forms.

With the base 16 closed, water inside the vehicle 3 becomes a part of the upper chamber 12 due to how the water is separated in the water tower 2.

Closing the recycle door 9 and then opening the base 16, denser than the walls of the vehicle 3, and disengaging from MLD 10 decompress the vehicle 3 walls back to its natural state. Vehicle 3 does not decompress without opening the base 16 when the recycle door 9 is closed.

USHP design allows some functions to be combined or performed differently than explained above. For example, the base 16 could be a part of MLD 10 rather than a part of the vehicle 3—so long as the base 16 serves the same function of separating the lower chamber 11 and the upper chamber 12 while the vehicle 3 is lifted. Or vehicle 3 could have motorized legs or gears to incorporate the MLD 10 functions.

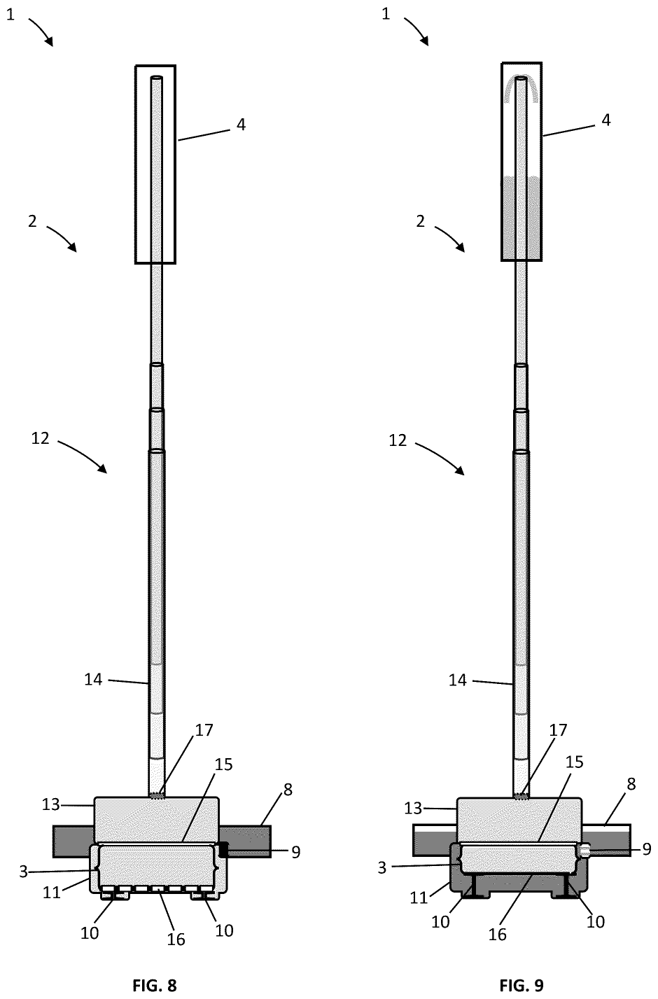

FIG. 8 through FIG. 12 show USHP in various stages of the operation. To focus on the water tower 2, some components such as a penstock 6 and a turbine generator 7 are not shown in these figures.

FIG. 8 shows the initial settings for USHP 1 with the water tower 2 filled with water to the top of the head chamber 14. With the recycle door 9 closed, the vehicle 3 is at the bottom of the lower chamber 11 with the base 16 open. Upper reservoir 4 is shown empty to clearly show water movement during subsequent phases of operations.

FIG. 9 shows that the lower chamber 11 and the upper chamber 12 are separated by closing the base 16. Before operating MLD 10, open the recycle door 9 to prevent suctioning effects to the vehicle 3. Opening both the base 16 and the recycle door 9 will drain the upper chamber 12. Placing a one-way waterflow valve 17 between the body chamber 13 and the head chamber 14 should be included in the overall system design especially for large capacity systems to prevent accidental water release from the head chamber 14.

FIG. 9 shows the vehicle 3 work like a plunger to push or pump water in the upper chamber 12 into the upper reservoir 4. As the vehicle 3 is lifted and compressed, its volume in the lower chamber 11 gets smaller making a void for water from the lower reservoir 8, through the recycle door 9.

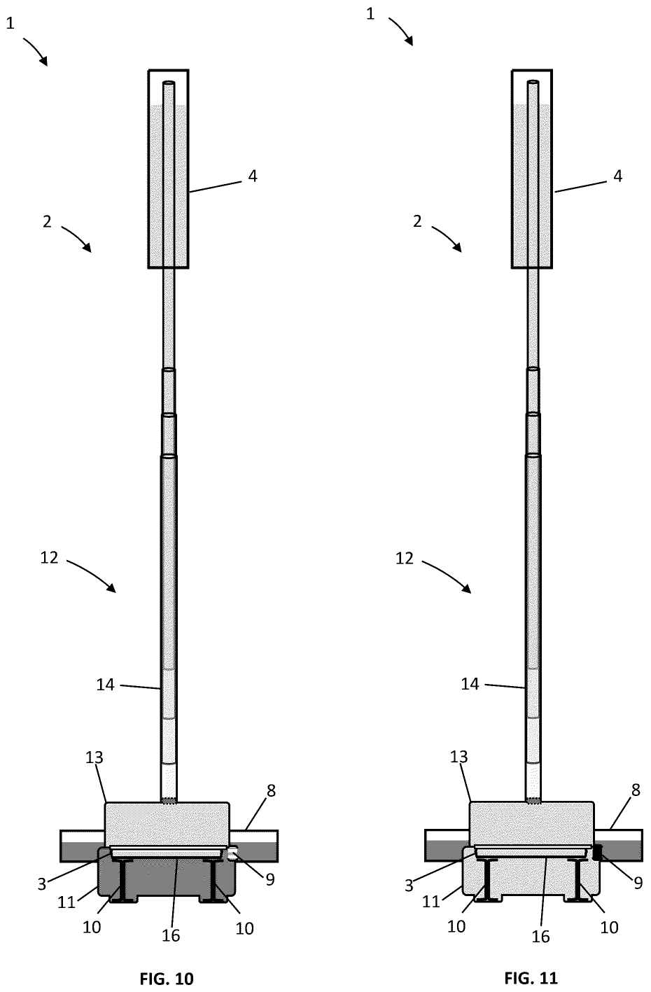

FIG. 10 shows the vehicle 3 lifted with the base 16 closed. FIG. 11 shows the water tower 2 is full of water and separated from the lower reservoir 8 with the recycle door 9 closed.

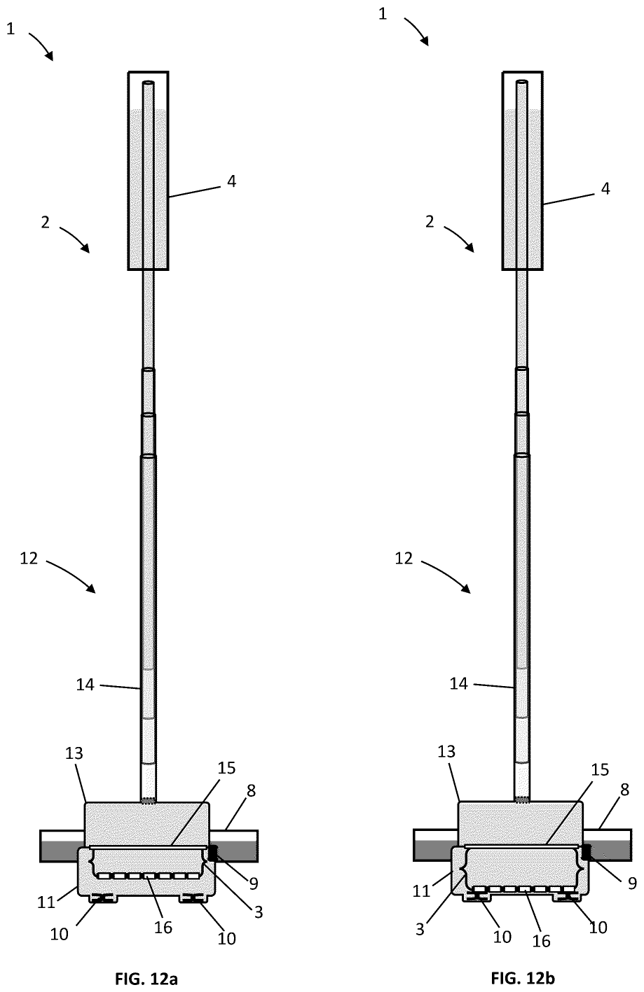

With the recycle door 9 closed, disengage and lower MLD 10, and open the base 16 to start decompressing the vehicle 3 walls as shown in FIG. 12a. The base 16, denser than the walls of the vehicle 3, sinks and stretches compressed walls of the vehicle 3. MLD 10 could help pull down the base 16 to restore the vehicle 3 shape faster. Once the vehicle 3 is at the bottom of the lower chamber 11 (FIG. 12b), operations may be repeated.

Water level in the upper reservoir 4 and the lower reservoir 8 change as the vehicle 3 is lifted. The upper reservoir 4 and the lower reservoir 8 are separate from the water tower 2. Water tower 2 is kept full of water throughout USHP normal operations since the void gets filled real-time through the recycle door 9. Importance of this is discussed in the Energy Calculations section below.

To generate electricity and to replenish the lower reservoir 8, USHP releases the upper reservoir 4 water through a reservoir release valve 5. The lower reservoir 8 receives hydro discharge at the lower reservoir entrance 18 (FIG. 1).

The upper chamber 12 has a unique combination of a body chamber 13 and a head chamber 14. The body chamber 13 shape and volume should be just large enough to accommodate the vehicle 3 movement. More specifically, the body chamber 13 volume needs to match the change in the vehicle 3 volume in the lower chamber 11.

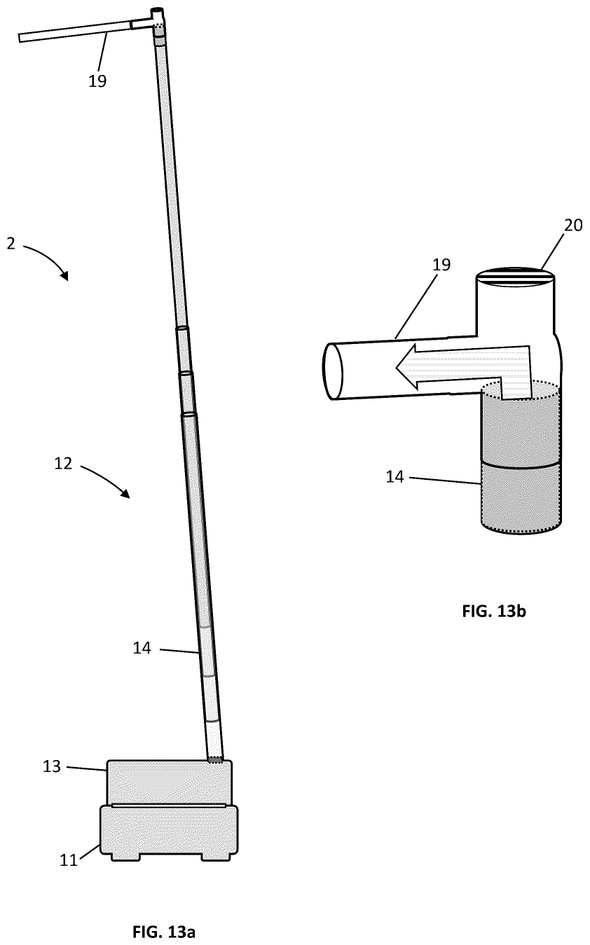

For PSH applications, in some instances, it might be useful to have the head chamber 14 at an angle to connect to the upper reservoir 4 which is likely some distance away. FIG. 13a shows the head chamber 14 supply water through a connecting pipe 19 to upper reservoir 4 (not shown). FIG. 13b shows the top portion of FIG. 13a focusing on the connecting pipe 19 with a top vent 20 that is open and tall enough to prevent pumped water from escaping, and to allow free waterflow to the connecting pipe 19 from the head chamber 14.

USHP design provides flexibilities to adapt to the applications and the environment. For example, as shown in FIG. 1, the head chamber 14 is a telescopic pipe and could be retracted or extended for maintenance or for other reasons including enhanced capacity operations. A penstock 6 could be telescopic as well (FIG. 1) matching the head chamber 14 height.

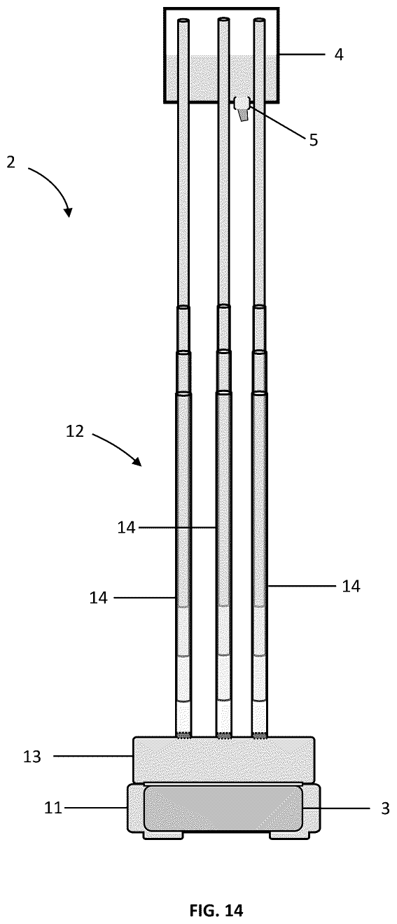

FIG. 14 shows a common upper reservoir 4 for multiple head chamber 14.

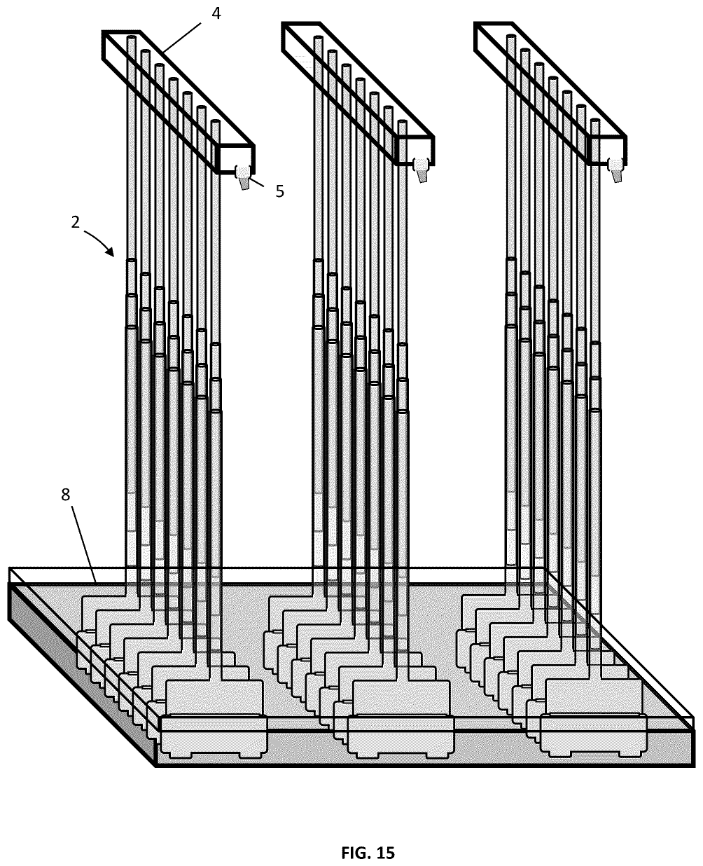

FIG. 15 shows a perspective of a USHP farm of 21 units (arbitrarily chosen) that could fit into ˜0.5 acres of land, with each row sharing a common upper reservoir 4. There could be more than one release valve 5 in each upper reservoir 4. USHP farm could share a common lower reservoir 8 with a separate recycle door 9 to each USHP unit. FIG. 15 intentionally does not show many details at the component level to provide a high-level perspective of a USHP farm. For a qualitative comparison, a single 2-MW WTG would need ˜1.5 acres of land. Solar panels require ˜10-acres of land for 2-MW capacity.

For a small capacity of ˜100-kilowatt range, systems may be built at a factory with minimal assembly at the job site. Transport these mini USHP systems where needed, add water, and operate. Since USHP could be operated next to each other, it would be relatively easy to scale up and build a mini USHP farm in a matter of days.

USHP allows for easy starts and stops using MILD 10 which could be a hydraulic lift motor or a motor operating a linear gear to manage the vertical movement of the vehicle 3. Lifting a large, heavy vehicle 3 repeatedly for an extended period—requires careful assessments as to how and where to stage and operate MLD 10. Planning for maintenance, repair and replacement should be considered.

MLD 10 could be placed in different locations such as alongside rather than from the bottom of the vehicle 3. MLD 10 could be operated from from the top of the body chamber 13 as well. MLD 10 could lock a vehicle 3 in any position within its allowed range. There is no need for separate brakes to stop and hold the vehicle 3.

For multiple units of USHP, sharing a common upper reservoir 4 could minimize the overall reservoir size while improving the combined system structural integrity. Upper reservoir 4 could have many different shapes and volume. For SPP applications, USHP could have an upper reservoir 4 placed around or near the top of the head chamber 14 (FIG. 1).

### USHP Operations

USHP relies on redundant sensors for monitoring water flowrate, water volume and water level as well as operating all components. The lower reservoir 8 continuously maintains its water level higher than the top of a lower chamber 11 via hydro discharge throughout operations.

Before starting an operation, the following initial settings of USHP 1 need to be established as shown in FIG. 8:
a) a recycle door 9 is closed;
b) a base 16 of the vehicle 3 is open;
c) a water tower 2 is filled with water to the top of a head chamber 14;
d) a vehicle 3 is at the bottom of the lower chamber 11. FIG. 8 shows darker gray for the lower reservoir 8 compared to the water tower 2—to clearly show they are not connected at this stage with the recycle door 9 closed.

Once these USHP 1 initial settings, as shown in FIG. 8, are verified using multiple redundant sensors, start the operation by performing and ensuring following sequential tasks, i.e., after each task is completed and verified, the next task is performed automatically:
1) Close the base 16 disconnecting the lower chamber 11 and the upper chamber 12. Water inside the vehicle 3 is now a part of the upper chamber 12.
2) Open the recycle door 9 that connects the lower chamber 11 and the lower reservoir 8 as shown in FIG. 9. Both the lower reservoir 8 and the lower chamber 11 are shown in the same darker gray to show that they are in a fluid communication.
3) Use MILD 10 to lift the vehicle 3 as shown in FIGS. 9 and 10. Since the water tower 2 is already filled to the top of head chamber 14, lifting the vehicle 3 moves water in the upper chamber 12 out of the water tower 2 and into the upper reservoir 4 as shown in FIG. 9. Water from the lower reservoir 8 fills the void through the recycle door 9.
4) When the vehicle 3 is lifted (FIG. 10), close the recycle door 9 (FIG. 11).
5) Open the base 16 (FIG. 12a). The water tower 2 is filled with water throughout the operations.
6) Disengaging the vehicle 3 from MLD 10 (FIG. 12a), with the base 16 open, decompresses the vehicle 3 walls, restoring the initial settings (FIG. 12b).
7) Verify initial settings a)-d) in the USHP operations are restored before repeating the operations following the steps 1)-6).

It should be noted that lifting the vehicle 3 requires MLD 10 also lift water above the vehicle 3 in the upper chamber 12. The water column volume above the vehicle 3 is not uniform since the head chamber 14 cross sections are smaller than the body chamber 13. This is a very important feature of USHP. Additional discussions of USHP are provided below.

### Energy Calculations

Assume a simple shape for a vehicle 3 with compressible walls, open top, and a bottom base 16. With the base 16 closed, the vehicle 3 separates the lower chamber 11 and the upper chamber 12. With base 16 open, the entire water tower 2 is one body of water since the lower chamber 11 and the upper chamber 12 are connected. The vehicle 3 volume and mass are calculated with its base 16 closed with water in the vehicle 3.

Consider three cases with the same vehicle 3 volumes of 30-m³ for USHP to generate electricity comparable to a 2-MW WTG. Different heights for the vehicle 3 and the head chamber 14 are selected to highlight the importance of the head chamber 14 to USHP. The head chamber 14 height is adjusted to produce the head of either 50-m or 100-m. Head is assume to be the vertical distance between the top of the head chamber 14 and the hydro input elevation to the turbine generator 7 which is assumed to be about 1-m above the lower chamber 11.

In rough order calculations, it is assumed that the vehicle 3 could be compressed 100%. In all three cases, each time a vehicle 3 is lifted, 30-m³ of water is pumped into an upper reservoir 4. The total mass USHP has to lift is defined as the sum of mass of the vehicle 3 and the water column above the vehicle 3.

In simple terms, lifting a vehicle 3 pushes water out of the upper chamber 12 and into the upper reservoir 4. Before starting an operation, fill the water tower 2 to the top of the head chamber 14. Throughout operations, the following is observed:
Volume of water pumped into an upper reservoir 4
=Vehicle 3 volume change in the lower chamber 11
=Void volume in the lower chamber 11
a) Vehicle 3 height (h) and radius (r): h=5-m, r=˜1.38-m.
   Vehicle 3:
      volume: π×(r)²×5-m=30-m³
      water loaded mass: 31 MT
         [overall ˜3% denser than water]
      movement range: 0 to 5-m [vehicle 3 height]
   Low chamber 11: h=5-m [vehicle 3 height]
   Body chamber 13: h=5-m
      water volume above vehicle 3: 30-m³=30 MT
   Head chamber 14: h=46-m, r=0.3-m
      water volume: 13-m³=13 MT
   Total-mass to be lifted
      =vehicle 3+water above vehicle 3
      =(31+30+13) MT=74 MT
   Energy to lift total-mass by 5-m:
      ET=74000-kg×9.8 m/s²×5-m
   Head (from 1-m above lower chamber 11):
      50-m=(5-m−1-m)+46-m
   Ideal maximum capacity: 30-m³ of water at 50-m
      13 MJ≅(30000-kg×9.8 m/s²×50-m)−ET
b) Vehicle 3: h=2-m, r=−2.19-m.
   Vehicle 3:
      volume: 30-m³
      water loaded mass: 31 MT
      movement range: 0 to 2-m
   Low chamber 11: h=2-m [vehicle 3 height]
   Body chamber 13: h=2-m
      water volume above vehicle 3: 30-m³=30 MT
   Head chamber 14: h=49-m, r=0.3-m
      [3-m longer than 5-m case for the same head]
      water volume: ˜14-m³=14 MT
   Total-mass to be lifted
      =vehicle 3+water above vehicle 3
      =(31+30+14) MT=75 MT
   Energy to lift total-mass by 2-m:
      ET=75000-kg×9.8 m/s²×2-m
   Head (from 1-m above lower chamber 11):
      50-m=(2-m−1-m)+49-m
   Ideal maximum capacity: 30-m³ of water at 50-m
      13 MJ≅(30000-kg×9.8 m/s²×50-m)−ET
c) Vehicle 3: h=2-m, r=−2.19-m.
   Vehicle 3: [same as in b)]
      volume: 30-m³
      water loaded mass: 31 MT
      movement range: 0 to 2-m
   Low chamber 11: h=2-m [same as in b)]
   Body chamber 13: h=2-m [same as in b)]
      water volume: 30 MT [same as in b)]
   Head chamber 14: h=99-m, r=0.3-m
      water volume above vehicle 3: 28-m³=28 MT
      [˜twice the height and mass of b)]
   Total-mass to be lifted
      =vehicle 3+water above vehicle 3
      =(31+30+28) MT=89 MT
   Energy to lift total-mass by 2-m:
      ET=89000-kg×9.8 m/s²×2-m
   Head (from 1-m above lower chamber 11):
      100-m=(2-m−1-m)+99-m
   Ideal maximum capacity: 30-m³ of water at 100-m
      27.7 MJ≅(30000-kg×9.8 m/s²×100-m)−ET

It may not be obvious as to how USHP could convert the mechanical energy of lifting the vehicle 3 to produce substantially more hydro potential energy. The answer is in how USHP is prepared and operated.

It may be useful to compare USHP and a hot air balloon. Hot air balloon initially requires filling a deflated balloon with hot air—like filling an empty water tower 2. This initial preparation requires a lot of energy and proportionally more as the system capacity increases. As a bigger balloon could carry more mass, bigger the water tower 2, more energy could be generated.

Starting USHP with the water tower 2 filled with water is equivalent to preparing the hot air balloon filled with hot air in an upright position on the ground. At this point, applying relatively small additional energy, compared to preparing the systems initially, will drive the systems in motion. Major difference between a hot air balloon and USHP is that the hot air balloon loses hot air much more rapidly than USHP loses water through evaporation—whether the system is idle or in motion.

Maintaining the water tower 2 filled with water, to the top of the head chamber 14, would be like keeping the hot air balloon ready for a takeoff in an upright position on the ground. USHP effectively and efficiently uses its initial energy of filling the water tower 2. As USHP pumps, water into the upper reservoir 4, the void in the lower chamber 11 gets filled with water simultaneously—through the recycle door 9.

The inner cross section of the head chamber 14 needs to be smaller than that of the body chamber 13; otherwise, USHP would not realize desired efficiencies. Flowrate into the upper reservoir 4 is a critical parameter that help define the USHP capacity. USHP is a large hydro-mechanical system that would complete a few cycles of operation per minute. Optimizing the flowrate as a function of the head section 14 diameter to the upper reservoir 4 is important.

USHP uses negative buoyancy of the vehicle 3 to restore the vehicle 3 back to the initial position for repeat operations. Base 16, denser than the walls of the vehicle 3, should be in an open position to restore the initial settings. Just to complete the comparisons, hot air balloon releases hot air from the balloon to lower itself. While released hot air is no longer usable, the recycled water continues to fuel USHP.

In all three cases considered above, the same void volume (30-m³) is produced in the lower chamber 11 during each cycle and the same water volume (30-m³) is added to the upper reservoir 4 at different heights and then released for energy calculations.

Work required to lift the vehicle 3 from the bottom of the lower chamber 11 in the first two cases roughly have the same total mass of ˜75 MT. The 5-m tall vehicle 3 is lifted 5-m whereas the 2-m tall vehicle 3 lifted 2-m to produce the same void volume of 30-m³ in the lower chamber 11 since the lower chamber 11 height is designed to match the vehicle 3 height. Overall dimensions and especially the height of the vehicle 3 is a key parameter to optimize in the USHP design.

Although this is a simplistic view of a complex system, it clearly demonstrates that the shape and volume of the vehicle 3 affect the design of the water tower 2.

Compared to the second case, third case increased the head ˜100% but adds only ˜19% to the total mass (from 75 MT to 89 MT) to be lifted. Shape and volume of the vehicle 3 remain the same for both the second and the third cases. Making the head chamber 14 taller would not require changes to the rest of the water tower 2 including the vehicle 3.

USHP can increase the system capacity, within reason, by extending the height of the head chamber 14. This clearly differentiates USHP from VMSW water tower design and operations.

In the third case, MLD 10 is assumed to operate at a reasonable 0.1-m/sec taking ˜20-sec to lift the vehicle 3. In these calculations, an inner diameter of 0.6-m or 2-ft is used for the head chamber 14, which is a relatively large pipe diameter capable of delivering water at ˜1.5-m³/sec. It would take less than 10-sec to fully restore USHP 1 back to the initial settings: close the recycle door 9 and then open the base 16 to reposition the vehicle 3 to the bottom of the lower chamber 11. It is important to balance the MLD 10 lifting speed against power needed to operate the MLD 10.

For these approximate or rough order calculations, once MLD 10 starts lifting the vehicle 3, we have ignored that there is less and less water to be lifted in the upper chamber 12. For the third case, average total mass lifted is ˜74-m³: initially ˜89-m³ and ends with ˜59-m³ as 30-m³ above the vehicle 3 has been pumped into the upper reservoir 4. Also, for simplicity, it is assumed that the vehicle 3 could be compressed 100% when it is more likely that compressibility would be 80% to 90%. These two factors likely will cancel out.

Potential energy available from 30-m³ of water at 100-m, after subtracting energy used to lift the total-mass, is ˜27.7 MJ. For power production, at ˜70% overall efficiency, USHP could generate ˜19.4 MJ every 30 sec generating ˜650 kW—comparable to the output from a 2-MW WTG. Although Energy Calculations are done with 30-m³ vehicle 3 volume, larger the vehicle 3 and taller the head chamber 14, more hydro potential energy could be harvested.

This is a crude estimation, looking primarily at the positive aspects of having a taller head chamber 14. There are engineering difficulties and other considerations by having taller head chamber 14, that will affect the overall performance.

Lifting ˜100 MT or more repeatedly is a difficult task. Either multiple (smaller) units of vehicle 3 could be used in the water tower 2 or the vehicle 3 itself could be segmented into multiple parts and lifted separately.

Time to lift a vehicle 3 depends on several factors, including the total mass USHP must lift and the smallest opening cross section in the upper chamber 12. In the examples considered above, the smallest opening through which USHP pump water is the head chamber 14 with 0.6-m inner diameter. The head chamber 14 diameter needs to be optimized against the total mass as increasing the diameter will increase the head chamber 14 water volume.

In addition to using power to operate an MLD 10, operating the rest of USHP equipment such as a base 16, a recycle door 9, etc. would benefit from having access to the grid, similar to WTGs, for example. USHP needs to have a standalone UPS (uninterruptible power supply) battery backup. As a figure of merit, power needed to operate a base 16 or recycle door 9 would be comparable to operating a garage door, for example, with ˜1 HP motor. The base 16 should close and open quickly.

### USHP Vs. VMSW

USIP claims significant changes and differences compared to the VMSW. It may be useful, even if casually, to compare the two systems. By using the same head, it is possible to compare the two systems pumping the same volume of water to their respective upper reservoirs—in about the same time.

Two systems differ in how they pump water into their respective upper reservoirs. USIP uses a vehicle that could be completely contained in its lower chamber, whereas VMSW relies on a positively buoyant driver that spans the entire length of its water tower. In more simple terms, assuming 100-m tall water towers for both, the vehicle 3 takes up ˜2% of the USHP water tower height and the VMSW driver is at least as tall as the VMSW water tower.

USHP lifts a vehicle 3 to pump water in the upper chamber 12 into the upper reservoir 4. The vehicle 3 volume is the upper limit of the pumped water. Vehicle 3 is negatively buoyant and sinks to the bottom of the lower chamber 11 to restore its shape and form when disengaged and not supported by MLD 10. Vehicle 3 has a relatively short height of less than 2-m as discussed above. The vehicle 3 height is the upper limit the vehicle 3 could be lifted.

VMSW moves a driver by changing the water level in the water tower. First, VMSW reduces the wide-section volume, using piston cylinders, to force the water level to rise. Then the driver is released to move up to maintain its neutrally buoyant point. The wide-section transfers water to the upper reservoir which lowers the water level and then the piston cylinders pull back to lower the water level even more. When released, the driver moves down and restores VMSW for repeat operations.

The USHP upper chamber 12 has two parts: a body chamber 13 and a narrow head chamber 14. The shape and volume of the body chamber 13, just above the vehicle 3, are roughly same as those of the vehicle 3. The body chamber 13 provides water for the vehicle 3 to pump into the upper reservoir 4. Cross section of the head chamber 14 is at least an order of magnitude smaller than that of the body chamber 13, and the head chamber 14 dimensions are not constrained by the vehicle 3.

The VMSW upper chamber has three parts, and the driver is present in all of them: narrow-section at the top followed by wide-section and long-section. For the same head, VMSW has to be taller than USHP water tower since the narrow-section of the upper chamber does not contribute to the head as the upper reservoir is at the wide-section level. VMSW would need a ˜1,000 MT driver for a 2-MW capacity system. USHP uses ˜30 MT vehicle 3 to generate the same output.

USHP prefers to use a relatively short and a large diameter vehicle 3, to minimize the amount work to pump water into its upper reservoir 4. For VMSW, increasing the driver diameter makes the entire water tower uniformly larger since the driver has to float following the water level in the water tower.

USHP simultaneously produces and fills a void in the lower chamber 11, while supplying water to an upper reservoir 4—unlike VMSW that requires multiple steps to change the water level in the water tower to move its driver to produce the void. Every additional step taken results in longer cycle time and reduces the system capacity.

According to U.S. Ser. No. 11/415,097B1, the driver, with a radius of 1.7-m and cross section of 9-m², should be raised ˜3.3-m to produce a void volume of 30-m³ in the VMSW lower chamber, which is the water volume transferred to its upper reservoir in the wide-section. Said differently, the VMSW water tower can't have cross section less than 9-m² anywhere. As discussed in the Energy Calculations above, the USHP head chamber 14 cross section, which is independent of the vehicle 3 dimensions, is only ˜0.3-m², 1/30^{th} of VMSW long-section, to pump 30-m³ of water into the upper reservoir 4. Making the vehicle 3 larger does not affect the head section 14 dimensions. Also, USHP could triple the cross section of the head chamber 14 and still be smaller by an order of magnitude compared to that of the VMSW long-section.

These are more of qualitative comparisons, but for USHP, the (compressible) vehicle 3 stays and operates in the lower chamber 11 and does not move into the upper chamber 12 whereas the VMSW driver spans the entire water tower.

### Water Tower 2

For multi-MW capacity systems, water tower 2 could be 100-m or taller—comparable to WTG height. Unlike WTGs, however, USHP could be built and operated next to each other (FIG. 15) or next to tall buildings, alongside bridges, or even at a hillside. USHP could leverage existing power transmission infrastructure or substantially minimize infrastructure needs since they could be built at or near the location of power consumption.

Multiple vehicle 3 units could operate in a single water tower 2 with one or more head chamber 14. For each vehicle 3, USHP may require separate lower chamber 11 and recycle door 9. This is a variation of having a segmented vehicle 3 that provides adjustable pumping capacity.

Head chamber 14 essentially could be a very long telescopic pipe that could be extended and retracted. The head chamber 14 could also be built by stacking or connecting multiple pieces.

It is preferred to have multiple units to form a USHP Farm. Each USHP unit operates independently to pump water into an upper reservoir 4 for immediate or later use.

For SPP applications, two or more USHP units could share a common upper reservoir 4 and a common lower reservoir 8 (FIG. 15) with a separate recycle door 9 for each USHP unit.

USHP could use panels that interlock to form and construct the water tower 2 with strategically placed connecting and support rods. By using liners to make the system watertight, the panels provide rigid structure to the chambers. Much of the water tower 2 could be prefabricated and assembled at the job site. Due to symmetrical shapes of the panels, they can be stacked for transportation and storage. Almost all the materials should be reusable or recyclable.

For SPP applications, building and operating USHP in extreme cold environment requires, for example, additional insulation, use of heating coils, use of salt water to lower the freezing temperature, and circulating water continuously. It is preferred to operate USHP in an enclosed environment.

### CONCLUSION

The preferred embodiments of the present invention provide innovative ways to recycle and supply a large volume of water from a lower reservoir to an upper reservoir for various applications including generating electricity. USHP substantially reduces the VMSW water tower dimensions introducing various vehicle designs to push or pump water in the upper chamber into an upper reservoir.

The USHP water tower has a unique combination of a lower chamber, designed for a vehicle to operate inside, and a slim upper chamber. The upper chamber further comprises a body chamber, just above the lower chamber, to provide water for the vehicle to be pumped, and a tall and slender head chamber.

The vehicle could take many different forms and shapes. USHP prefers a vehicle with compressible walls and a bottom base. With the base closed, the vehicle separates the lower chamber and upper chamber with no fluid communication between the chambers.

As the vehicle is lifted producing a void in the lower chamber, water from a lower reservoir fills the void real-time through a recycle door. Closing the recycle door and then opening the base combines all waters in the water tower that now includes the water that filled the void. For power production applications, there is no difference between the recycled water added to the lower chamber and the water that was in the water tower already.

The vehicle is denser than water. With the base open, the vehicle will restore its own form and reposition itself, with the MLD lowered, at the bottom of the lower chamber. This is an important feature for restoring the initial settings for repeat operations.

For both PSH and SPP applications, released water from the upper reservoir through a penstock turns a turbine generator, located at the ground level, to generate electricity. Hydro discharge or exiting water out of a turbine generator collect in the lower reservoir for reuse.

USHP is scalable. For hydropower systems, the head is proportional to the height of the upper chamber. Also, the larger the void, more water is pumped into the upper reservoir. The void in the lower chamber is determined by the vehicle's movement or change in its volume.

Since each USHP unit operates independently, a USHP farm with multiple units could operate continuously while allowing for rolling maintenance, repairs, and upgrades at the individual unit level. USHP farm could share a common lower reservoir and a common upper reservoir for more compact formations.

Although the invention has been explained in relation to its preferred embodiments, it is to be understood that many other possible modifications and variations can be made without departing from the spirit and scope of the invention.

The invention claimed is:

1. USHP, a hydro-mechanical system, for generating hydro potential energy and electricity comprising:
a water tower, filled with fluid, preferably water, further comprising:
a lower chamber;
an upper chamber; said upper chamber further comprises:
a body chamber just above said lower chamber;
a head chamber above said body chamber; said head chamber has smaller inner cross section than that of said body chamber; said body chamber and said head chamber are connected and share water or in a fluid communication;
a one-way waterflow valve between said head chamber and the body chamber to prevent accidental water release from said head chamber; any water movement in the upper chamber needs to be upward;
a chamber opening shared between the top of said lower chamber and the bottom of said upper chamber;
a vehicle, a term used exclusively to describe a device with which to move water in said water tower; said vehicle primarily operates in the lower chamber to push or pump water out of the top of said upper chamber; said vehicle comprising;
walls; said walls preferably maintain the shape of the cross section of said vehicle throughout operations;
a base; said base is used to combine or separate water between the lower chamber and upper chamber; the lower chamber and the upper chamber are separated when the base is closed;
an upper reservoir, for standalone power production (SPP) applications, preferably placed surrounding the top of the upper chamber to take in, hold, and release pumped water; top of the said upper reservoir is protected from weather elements but open or has a vent; placement of said upper reservoir is designed to maximize the head; said upper reservoir further comprises:
a connecting pipe between said upper reservoir and the top of said upper chamber when they are separated; said connecting pipe has a top vent;
a reservoir release valve to control water release from said upper reservoir;
a lower reservoir, a repository of water near said lower chamber, with its water level maintained above the top of the lower chamber, to collect, store, and supply water to said lower chamber; said lower reservoir further comprises:
a sliding watertight recycle door connecting to said lower chamber;
a hydro discharge entrance to receive exiting water from a turbine generator;
a penstock connected to the said reservoir release valve and extends down to a hydro turbine generator; said hydro turbine generator discharges water to a hydro discharge entrance and into the lower reservoir;
a mechanical lifting device (MILD), a motorized hydraulic mechanism to lift said vehicle; said MLD is preferably placed in said lower chamber and controls the vehicle's position; said MLD controls balancing of said vehicle at all times.

2. USHP of claim 1,
Wherein a preferred embodiment for said vehicle comprising:
a cylindrical or polygon shaped vehicle with top and bottom bases; stretchable watertight bellows secured between the top of the vehicle and said chamber opening to cover any gap while said vehicle is lifted from the lower chamber; said vehicle may be operated with the bottom base only; when the chambers are separated, the water inside the vehicle is a part of said upper chamber regardless of where said vehicle is positioned;
said vehicle could be segmented or made up of multiple parts and each part could be lifted independently;
said vehicle with compressible walls and a bottom base; said vehicle further comprises:
the top edge of said vehicle is secured and sealed around said chamber opening; when said base is closed, the lower chamber and the upper chamber are separated and no longer in a fluid communication;
said vehicle recovers its original form and shape with an open base when said MLD is disengaged from said vehicle and lowered and the recycle door is closed; said vehicle may have optional power components to help restore its own form and shape faster to its initial settings condition;
said vehicle volume establishes an upper limit for the void volume in the lower chamber and also the maximum amount of water pumped into the upper reservoir;
said vehicle's height determines that of the lower chamber; increasing the lower chamber height unnecessarily reduces the head; said vehicle's height establishes an upper limit for the vehicle lifting distance;
said vehicle's shape, volume, and its movement define the body chamber shape and volume; making the volume of said body chamber larger than necessary lowers the system capacity since MLD has to lift more water while delivering the same amount of water to the upper reservoir;
said vehicle has multiple layers in its vertical walls for a prolonged operation of continuous compression and decompression; USHP prefers to have said vehicle retain cross-sectional shape throughout operations;
wherein a plurality of vehicles could operate in a water tower with each vehicle with its own recycle chamber and recycle door;
wherein said head chamber could be extended or retracted; said penstock could be extended or retracted to match the height of the said head chamber;
wherein the head chamber height could be made taller to increase USHP system capacity without requiring modifications to the rest of the water tower;
wherein the inner cross section of the head chamber could change anywhere in the head chamber;
wherein said water tower could have covers on the exposed parts to reduce water loss through evaporation; said water tower operations are not affected by weather.

3. Multiple USHP systems form a USHP farm; said USHP farm further comprising:
a common lower reservoir for a subset of USHP systems; use of said common reservoir allows more compact configuration requiring even less land;
a common upper reservoir for a subset of USHP systems; said common upper reservoir could release more water per unit time than an individual system and support the use of a larger scale turbine generator; use of said common upper reservoir allows overall smaller upper reservoir capacity than the sum of individual upper reservoirs.

4. A method of recycling and pumping water for energy storage and predictable and steady energy production, said method comprising steps of:
a) establishing the initial settings, to which USHP will return to—after completing each cycle of operations, comprising:
a recycle door is closed;
a vehicle base is open;
a water tower is filled with water to the top of a head chamber;
MLD is lowered and positioned at the bottom of the vehicle; said MLD is ready to push the edges of the base;
b) once these USHP initial settings, as described in step 4-a), are verified using multiple redundant sensors, start the operation by performing and ensuring following sequential tasks, i.e., after each task is completed and verified, the next task is performed automatically:
1) close said base separating said lower chamber and said upper chamber and ensure there is no fluid communication between these chambers;
2) open said recycle door that connects said lower chamber and said lower reservoir; when there is no fluid communication between the lower chamber and the upper chamber, without opening the said recycle door, said vehicle could not be moved; while the recycle door remains open, said vehicle base remains closed to prevent drainage or leakage from the upper chamber; said lower reservoir continues to maintain its water level higher than the top of said lower chamber;
3) use MLD to lift said vehicle with its base closed; since said water tower is already filled with water, lifting said vehicle moves water out of the upper chamber and into the upper reservoir through the top of the head chamber;
4) water from the lower reservoir fills said void through a recycle door as the void is produced; throughout the process, the original water volume, as defined in said initial settings, in said lower chamber does not change; the volume of said void comes from the portion of said vehicle no longer in said lower chamber;
5) after verifying said lower chamber is filled with water from the lower reservoir, close said recycle door;
6) open said base;
7) release and disengage said vehicle from MILD to restore said vehicle to the initial settings; said MILD is lowered or retracted to allow said vehicle, denser than water, to sink and decompress; said MLD could assist the vehicle to recover its form back to the initial settings by pulling it down;
8) verify the initial settings are restored, as described in step 4-a) before repeating the operations following steps 4-b-1) to 4-b-7);
9) independent of the previous steps from 4-b-1) to 4-b-7), having validated using multiple sensors that there is sufficient water in said upper reservoir, continuously release water from said upper reservoir for energy conversion and power production; hydro discharge or exiting water from a turbine generator is collected in the lower reservoir for continuous recycling.
